(19) United States
(12) Patent Application Publication
(10) Pub. No.: US 2021/0104885 A1
(43) Pub. Date: Apr. 8, 2021

(54) Inductive Power Transfer Unit and a Method of Manufacturing an Inductive Power Transfer Unit

(71) Applicant: Bombardier Primove GmbH, Berlin (DE)

(72) Inventor: Martin Dechert, Heltersberg (DE)

(21) Appl. No.: 16/499,951

(22) PCT Filed: Apr. 3, 2018
(86) PCT No.: PCT/EP2018/058401

§ 371 Date: Oct. 1, 2019

(30) Foreign Application Priority Data
Apr. 7, 2017 (GB) 1705651.6

(51) Int. Cl. H02H 5/08; H01H 83/14; H02H 3/33; H02J 50/12

(52) U.S. Cl. CPC H02H 5/083; H02J 50/12; H02H 3/334; H01H 83/144

(57) ABSTRACT

The invention relates to an electronic unit and a method of manufacturing an electronic unit (1), wherein the unit (1) comprises at least electronic component, wherein the unit (1) comprises at least one housing (2) for the at least one electronic component (4, 5, 6, 7) of the unit (1), wherein the unit (1) comprises at least one auxiliary power supply line (8), wherein the unit (1) further comprises an RCD switch element (12), wherein the at least one auxiliary power supply line (8) is fitted with the RCD switch element (12) and at least one exposed section (19) in such a manner that the RCD switch element (12) triggers when the at least one exposed section (19) of the auxiliary power supply line (8) is exposed to a conductive fluid, wherein the at least one exposed section (19) is arranged in a fluid collection volume of the housing.

The invention relates to an inductive power transfer unit for transferring power inductively, in particular to a vehicle. Further invention relates to a method of manufacturing such an inductive power transfer unit.

Electric vehicles, in particular a track-bound vehicle, and/or a road automobile, can be operated by electric energy which is transferred by means of an inductive power transfer. Such a vehicle may comprise a circuit arrangement which can be a traction system or a part of a traction system of the vehicle, comprising a receiving device adapted to receive an alternating electromagnetic field and to produce an alternating electric current by electromagnetic induction. Furthermore, such a vehicle can comprise a rectifier adapted to convert an alternating current (AC) to a directing current (DC). The DC can be used to charge a traction battery or to operate an electric machine. In the latter case, the DC can be converted into an AC by means of an inverter. The inductive power transfer is usually performed using two sets of e.g. three-phase winding structures. A so-called primary winding structure is installed on the ground and can be fed by a wayside power converter (WPC).

The primary winding structure can be part of a primary unit or connected to a primary unit. The primary unit can e.g. comprise the wayside power converter and further auxiliary electronic components, e.g. control units.

A secondary winding structure is installed on the vehicle. For example, the secondary winding structure can be attached underneath the vehicle, in the case of trams under some of its wagons. For an automobile, it can be attached to the vehicle chassis. The secondary winding structure is usually part of a so-called pick-up-arrangement or receiving device or secondary unit. The secondary winding structure can be part of the secondary unit or connected to the secondary unit. The secondary unit can e.g. comprise the rectifier and further auxiliary components, e.g. control units.

The primary winding structure and the secondary winding structure form a high frequency transformer to transfer electric energy to the vehicle. This can be done in a static state (when there is no movement of the vehicle) and in a dynamic state (when the vehicle moves).

Power electronic components, e.g. components of an inverter of a primary unit or a rectifier of a secondary unit, can be arranged within a housing of the inductive power transfer unit. Water which penetrates into an inner volume or which collects in the inner volume of said housing, e.g. due to condensation, in which these power electronic components are arranged can decrease operational safety of the inductive power transfer unit.

The decrease of an operational safety due to water which penetrates into the inner volume and/or which collects in the inner volume decrease the operational safety not only in the case of an inductive power transfer unit. In general, the outlined scenario of water which penetrates and/or collects in a housing decreases the operational safety for every unit which comprises an electronic component arranged within a housing.

It is therefore a technical problem to improve the maintenance of the operational safety of an electronic unit, in particular an inductive power transfer unit.

The solution to said technical problem is provided by the subject-matter with the features of claims 1 and 12. Further advantageous embodiments are provided by the subject-matter with the features of the sub-claims.

It is a main idea of the invention to provide a RCD (residual-current device) in at least one auxiliary power supply line of the electronic unit, in particular of the inductive power transfer unit. A RCD can also denote a so-called RCCB (residual-current circuit breaker). In case of a fluid, e.g. water, ingress into the housing, the RCD will interrupt the auxiliary power supply line rapidly. This interruption, in turn, can lead to a deactivation of a main power supply of the electronic unit and/or a deactivation of further devices which are part of a main power supply of the electronic unit.

An electronic unit, in particular an inductive power transfer unit of a system for inductive power transfer, in particular to a vehicle, is proposed.

The electronic unit, which will also be referred to as unit in the following, comprises at least one electronic unit. The at least one electronic unit can e.g. be a power electronic component or an auxiliary electronic component. A component can denote a device which is operated by electric energy. Also, a component can denote a device which transfers electric energy, e.g. from an input to an output of the device, or is operated by electric energy. In particular, the component can be a device for telecommunication, an electric machine or an electrically powered pump.

In the context of this invention, an electronic component can also denote an electric component.

Further, the unit can comprise at least one auxiliary electronic component. An auxiliary electronic component can e.g. be a control unit, e.g. a micro controller. Further, an auxiliary electronic component can e.g. be a relay or a fan for cooling electronic components. Of course, the auxiliary the electronic component can denote also further electronic components of the unit.

The unit further comprises at least one housing for electronic components of the unit. The at least one electronic component, in particular the at least one power electronic component and/or the least one auxiliary electronic component, can e.g. be arranged in an inner volume of the housing.

The housing can comprise at least one section or portion which is made of electrically conductive material. It is also possible that the housing is made of electrically conductive material. Such a section/portion can also be referred to as exposed section/portion. Further, at least one section or portion of the housing can be electrically connected to a reference potential, in particular to a ground potential. In particular, the at least one section or portion which is made of electrically conductive material, i.e. the exposed section/portion, can electrically be connected to the ground potential.

An auxiliary supply voltage for the at least one auxiliary electronic component can be lower than a main power supply voltage of the at least one power electronic component. In particular, the auxiliary supply voltage can e.g. be 230 V AC (alternating current voltage). In contrast, the main power supply voltage of the at least one power electronic component can reach up to 400 V AC or 750 V DC or even higher.

The unit comprises at least one auxiliary power supply line. The auxiliary power supply line can also be denoted as monitoring line.

If the unit comprises at least one auxiliary electronic component, the auxiliary power supply line can be a supply line for supplying power to the at least one auxiliary electronic component. The unit can preferably comprise an auxiliary power return line and an auxiliary power feeding line. It is also possible that the unit comprises an auxiliary power protective line.

The at least one auxiliary electronic component can e.g. be electrically connected to the at least one auxiliary power supply line. Via the at least one auxiliary power supply line, the at least one auxiliary electronic component can be connectable to an auxiliary power supply unit outside the housing. The auxiliary power supply unit can e. g. provide the aforementioned auxiliary supply voltage.

It is, however, not absolutely necessary that the auxiliary power supply line is connected to an auxiliary electronic component. It is thus also possible that the unit comprises an auxiliary power supply line but no auxiliary electronic component.

According to the invention, the unit comprises a RCD. The RCD can also be referred to as residual current circuit breaker. Further, the at least one auxiliary power supply line is fitted with the RCD. It is e. g. possible that the auxiliary power supply line is wired through contact terminals of the RCD. It is thus possible to interrupt the auxiliary power supply line by the RCD, in particular if the RCD adopts an open state. If the RCD adopts a closed state, an electric connection between the at least one auxiliary electronic component connected to the auxiliary power supply line and an auxiliary power supply unit can be provided.

Further, the at least one auxiliary power supply line is fitted with at least one exposed section. An exposed section of the at least one auxiliary power supply line can be a section in which a current-carrying portion of the auxiliary power supply line can be contacted by a fluid, in particular an electrically conductive fluid. In the case of a fluid contact, the current-carrying-portion can be electrically connected to the fluid. It is possible that a feeding line is fitted with at least one exposed section. A feeding line can also be referred to as live wire.

The auxiliary power supply line can denote a feeding line. The unit can, however, comprise multiple auxiliary power supply lines, e.g. the feeding line and a return line. It is also possible that the unit comprises an additional protective line as an auxiliary power supply line.

If the unit comprises multiple auxiliary power supply lines, at least the feeding line is fitted with an exposed section. It is e.g. possible that only the feeding line is fitted with at least one exposed section, wherein the remaining auxiliary power supply lines are not fitted with an exposed section. Alternatively, at least one of the remaining auxiliary power supply lines can also be fitted with an exposed section. If the unit comprises a feeding line and a protective line, both of them can be fitted with at least one exposed section. It is possible but not necessary that the return line is fitted with at least one exposed section.

A fluid can e.g. be water such as brack water, rain or urine. Further, a fluid can be cooling fluid, e.g. from a vehicle or from a cooling system of the unit.

Further, the at least one auxiliary power supply line is fitted with the at least one RCD and the at least one exposed section such that the RCD triggers or trips if the at least one exposed section is exposed to a conductive fluid.

Further, the at least one exposed section is arranged in a fluid collection volume of the housing. The fluid collection volume of the housing can denote a portion of the inner volume in which fluid, in particular ingressing or condensing fluid, will collect. Given a dry housing, fluid will first and/or only collect or accumulate within the fluid collection volume of the housing, e.g. due to a gravitational force exerted on the fluid and/or other physical effects. Further, the at least one exposed section of the housing can be arranged in the fluid collection volume. Further, all exposed sections, e.g. of auxiliary power supply lines and/or the housing, can be arranged in the fluid collection volume.

The fluid collection volume can e. g. be a volume comprising a bottom area of the housing or a bottom part of the inner volume. In this case, the fluid collection volume can be arranged within a bottom section of the housing.

A bottom area or bottom part can denote an area/part of the inner volume at a bottom side of the housing. In an installed state of the unit, the bottom area/part can denote the lowest area/part with respect to a vertical direction which can be oriented parallel to a direction of a gravitational force.

Preferably, the at least one exposed section is arranged below the at least one electronic component, in particular below the at least one power electronic component, preferably below all power electronic components, with respect to said vertical direction.

In other words, the at least one auxiliary power supply line can be designed and/or arranged, e.g. routed, such that a fluid which collects within the housing will contact the at least one exposed section, in particular as soon as it collects within the housing or at least before contacting electronic components, and will thus generate a residual current which, in turn, trips the RCD. It is further possible that the fluid will contact a further exposed section of (another) auxiliary power supply line or an electrically conductive portion of the housing. In particular, the auxiliary power supply line can be routed along a bottom section of the housing.

This advantageously allows detecting fluid inside the housing before said fluid contacts power electronic components. Thus, an operational safety of the unit is further increased.

Further advantageously, the invention allows for a detection of a fluid inside the housing without the need to provide mandatory additional detection means or mandatory evaluation logics and their implementation on processing units. This leads to a greatly reduced cost for manufacturing and maintaining the unit or a system comprising the unit.

It can be assumed that fluid which penetrates or condenses in the housing or which collects in the housing in which the at least one section of the at least one auxiliary power supply line is arranged will lead to a fault or residual current. The residual current can e.g. flow from between the at least one exposed section, e.g. of the feeding line, and a ground potential. The ground potential can e.g. be provided by a housing or a section of the housing connected to the ground potential, an unexposed section of a protective line connected to the ground potential or any other means providing the ground potential.

Thus, it is possible that the unit comprises at least one means for providing a ground potential, in particular in the inner volume of the housing and/or electrically accessible from the inner volume of the housing. Said means can e.g. be provided by the housing or a section thereof and/or the unexposed section of the protective line which is/are connected to ground potential.

Such a fault or residual current will trip the RCD. In particular if such a residual current occurs, the RCD can change from a closed state to an open state. In the open state, the auxiliary power supply of the at least one auxiliary electronic component can be interrupted. If the unit comprises an auxiliary electronic component connected to the auxiliary power supply line, an operation of said component will be affected, e.g. interrupted. This, in turn, can lead to an easy detection of a detected residual current. Further, this can lead to an easy detection of an undesired interruption of the auxiliary power supply line which is different from the interruption generated by the RCD. Such an undesired interruption can e.g. be a wire breakage. Connecting an auxiliary electronic component to the auxiliary power supply line therefore also allows to easily monitor a functionality of the auxiliary power supply line.

This interruption of auxiliary power supply can also be detected, e. g. by an evaluation unit of the unit. Further, the interruption of the auxiliary power supply can lead to an interruption of the main power supply for unit. This interruption of the main power supply can e. g. be provided by software or hardware means if the interruption of auxiliary power supply is detected.

In summary, fitting a RCD to the at least one auxiliary power supply line allows a fast and reliable detection of residual currents, in particular due to fluid ingress into the housing or fluid collection within the housing, e.g. due to leakage of further fluidic components arranged within the housing, e.g. a cooling system. This detection, in turn, can be used to deactivate the main power supply and thus improve the maintenance of an operational safety of the unit.

Further, the risk of an electrolysis and resulting effects due to short circuit currents within the housing is reduced. This advantageously increases an application area of the unit, in particular to areas in which such resulting effects are undesired.

It is clear to the skilled person that the invention can be applied to any system in which a fluid collecting in an inner volume of a housing comprising electronic components, e.g. power electronic components and auxiliary electronic components, affects an operational safety of the system and an immediate deactivation of the system or a part thereof is desirable.

In another embodiment, the auxiliary power supply line has an internal section and an external section. The internal section can denote the section of the auxiliary power supply line which is arranged within the housing, in particular within an inner volume of the housing. The external section can denote the section of the auxiliary power supply line which is arranged outside of the housing. The housing can e. g. have an auxiliary supply line inlet through which the auxiliary power supply line can extend into the housing.

Further, the external section of the auxiliary power supply line is fitted with the RCD. This advantageously does not increase a volume of an installation space within the housing as the RCD is arranged outside the housing. Further, a simple installation, e. g. a back-fitting, of the RCD is provided.

In another embodiment, the unit comprises at least one main power supply line. The main power supply line can e.g. be connected to the electronic component arranged within the housing, in particular to the power electronic component. A main power supply voltage, e.g. an operating voltage, provided to the main power supply line can be higher than the auxiliary supply voltage provided to the auxiliary power supply line. Further, the at least one main power supply line is fitted with a supply line breaking means, e. g. a circuit breaker or a switch element. Further, the RCD has a trip signal interface. The trip signal interface can e. g. be provided by an auxiliary contact of the RCD. Further, the trip signal interface of the RCD is connected to the supply line breaking means, in particular a break signal interface of the supply line breaking means. Via said signal connection, a trip signal can be transmitted from the RCD to the supply line breaking means. Upon reception of the trip signal, the supply line breaking means can interrupt the main power supply line and thus the power supply to the power electronic components of the unit. It is e.g. possible that the supply line breaking means changes from a closed state into an open state if the trip signal is received. This advantageously allows a fast and reliable interruption of the main power supply of the unit.

If the unit comprises electrically operated means, e.g. a pump or a valve, for supplying fluid to a component within the housing, e.g. a fluidic component, it is also possible to interrupt a power supply line of said electrically operated means.

According to the aforementioned connection of the trip signal interface of the RCD to the supply line breaking means, it is e.g. possible that power supply line of the electrically operated means for supplying fluid is fitted with a supply line breaking means, e. g. a circuit breaker or a switch element, wherein the trip signal interface of the RCD can be connected to said supply line breaking means.

In this case, the supply of fluid into the housing can be interrupted or reduced. If the fluid which collects in the housing results from a leakage of the fluidic components within the housing, the proposed interruption further increases an operational safety.

In another embodiment, the unit comprises at least one evaluation unit. The evaluation unit can e. g. be provided by a microcontroller. A power supply of said evaluation unit can be provided independently of the auxiliary power supply line fitted with the RCD, e.g. by a further auxiliary power supply line.

An interrupted state of the at least one auxiliary power supply line is detectable by the at least one evaluation unit. If such an interrupted state is detected, a failure signal can be generated by the evaluation unit. The failure signal can be used to interrupt an operation of the unit or a system comprising the unit or to interrupt a main power supply of the unit and/or to generate an information for a user or supervisor of the unit or a system comprising the unit, e.g. by a higher-level system or by the evaluation unit itself.

If the unit comprises means for supplying fluid to a component within the housing, e.g. a fluidic component, it is also possible to interrupt or reduce a fluid flow into the housing if an interrupted state is detected. If the unit comprises at least one fluidic component, e.g. a cooling system component, a flow of fluid, e.g. cooling fluid, can be interrupted or reduced, e.g. by deactivating a corresponding pump and/or by closing a valve of a fluid inlet of the housing. In this case, the supply of fluid into the housing can be interrupted or reduced. If the fluid which collects in the housing results from a leakage of the fluidic components within the housing, the proposed interruption further increases an operational safety.

In another embodiment, the at least one exposed section comprises or is provided by at least one uninsulated or stripped section of the at least one auxiliary power supply line. In particular, the at least one uninsulated section is arranged within the housing, in particular within an installation space of the power electronic components. It is thus possible that the internal section of the auxiliary power supply line is fitted with at least one uninsulated section. The non insulated section can be provided such that there is no electric contact of the non insulated section to other components or parts of the unit in a normal state of the unit.

If fluid, in particular an electrically conductive fluid, contacts the uninsulated section, the aforementioned residual current can occur. Providing an uninsulated section therefore advantageously provides a desired sensitivity of fluid detection within the housing.

In another embodiment, the at least one exposed section comprises or is provided by at least one series terminal. The at least one series terminal can provide the at least one uninsulated section of the auxiliary power supply line. The at least one series terminal can be arranged within an inner volume of the housing, in particular in an installation volume of the at least one power electronic component. Fitting at least one, preferably multiple, series terminal(s) to the auxiliary power supply line advantageously provides a simple provision of an uninsulated section with a high operational safety.

In another embodiment, the fluid collection volume is arranged in a bottom section of the housing. This and corresponding advantages have been explained before.

In another embodiment, the housing is shaped such that the fluid collection volume is the part of the inner volume of the housing in which a fluid accumulates at first, in particular before the fluid collects in a part in which electronic components are arranged. This and corresponding advantages have been explained before.

In another embodiment, the unit comprises at least one fluid collecting element, wherein the fluid collecting element is designed and/or arranged such that a fluid collected by the fluid collecting element contacts the at least one exposed section.

The fluid collecting element can e.g. be an element which collects fluid from humid air within the inner volume of the housing. The fluid collecting element can e.g. be a condensing element at which fluid condenses. Alternatively, the fluid collecting element can collect fluid chemically, e.g. by silicate, or by fluid-mechanical effects such as condensation, a capillary effect.

Alternatively, the fluid collecting element is designed and/or arranged such that a residual current occurs if the fluid collecting element has collected a predetermined amount of fluid. It is e.g. possible that the fluid collecting element is provided by a humidity-sensitive insulation of an auxiliary power supply line, wherein the fluid collecting element is designed and/or arranged such that an electric contact between a current-carrying portion of the auxiliary power supply line and another current-carrying portion of the auxiliary power supply line or a conductive portion of the housing is established if the fluid collecting element has collected a predetermined amount of fluid.

Such a fluid collecting element advantageously allows to deactivate the power supply before fluid collects in a volume outside the fluid collecting element.

In another embodiment, the unit comprises at least one power electronic component and at least one auxiliary electronic component. This has been explained before.

In another embodiment, the electronic unit is an inductive power transfer unit. The inductive power transfer unit can be a primary unit or a secondary unit. In case of a primary unit, the unit can comprise at least one inverter or wayside power converter which provide a power electronic component. The inverter/converter can comprise at least one switching element, e.g. a MOSFET or an IGBT. In case of a secondary unit, the unit can comprise at least one rectifier which provides a power electronic component. The rectifier can comprise at least one diode.

The system for inductive power transfer can comprise said primary unit and the secondary unit. The primary winding structure can be part of or connected to the primary unit. The secondary winding structure can be part of or connected to the secondary unit.

The vehicle can comprise a secondary unit for receiving an alternating electromagnetic field which is generated by the primary winding structure. The primary winding structure generates the alternating electromagnetic field if the primary winding structure is energized or supplied with operating currents. The primary unit can comprise a totality or a subset of components by which an alternating electromagnetic field for inductive power transfer is generated, in particular a power converter. Correspondingly, the secondary unit can comprise a totality or a subset of components by which the alternating electromagnetic field for inductive power transfer is received and a corresponding output voltage is provided, in particular a rectifier.

The primary unit can be provided by an inductive power transfer pad. An inductive power transfer pad can be installed on the surface of a route or a parking space or it can be integrated within such a surface.

The present invention can be applied in particular to the field of inductive energy transfer to any land vehicle, for example track bound vehicles, such as rail vehicles (e.g. trams). In particular, the invention relates to the field of inductive energy transfer to road automobiles, such as individual (private) passenger cars or public transport vehicles (e.g. busses).

Further proposed is a method of manufacturing an electronic unit, in particular an inductive power transfer unit of a system for inductive power transfer, in particular to a vehicle. The method comprises the steps of
providing a housing of the inductive power transfer unit having a fluid collection volume,
arranging an electronic component within the housing, in particular a power electronic component,
providing at least one auxiliary power supply line having at least one exposed section,
arranging the exposed section in the fluid collection volume,
providing at least one RCD,
fitting the at least one RCD to the at least one auxiliary power supply line.

The method can further comprise at least one of the following steps: providing at least one means for providing a ground potential, in particular in the inner volume of the housing, arranging an auxiliary electronic component within the housing, connecting the at least one auxiliary power supply line to the at least one auxiliary electronic component, providing a main power supply line and connecting at least one main power supply line to the at least one power electronic component. The method advantageously allows providing a unit according to one of the embodiments disclosed in this disclosure.

In another embodiment, at least one main power supply line and at least one supply line breaking means is provided, wherein the at least one main power supply line is fitted with the supply line breaking means, wherein a trip signal interface of the RCD is connected to the supply line breaking means, in particular to a switch signal interface of the supply line breaking means. This and corresponding advantages have been explained before.

In another embodiment, the at least one exposed section comprises or is provided by an uninsulated section or at least one series terminal. This and corresponding advantages have been explained before.

The invention will be described with reference to the attached figures. The figures show:

FIG. 1: A schematic block diagram of an inductive power transfer unit according to the invention,

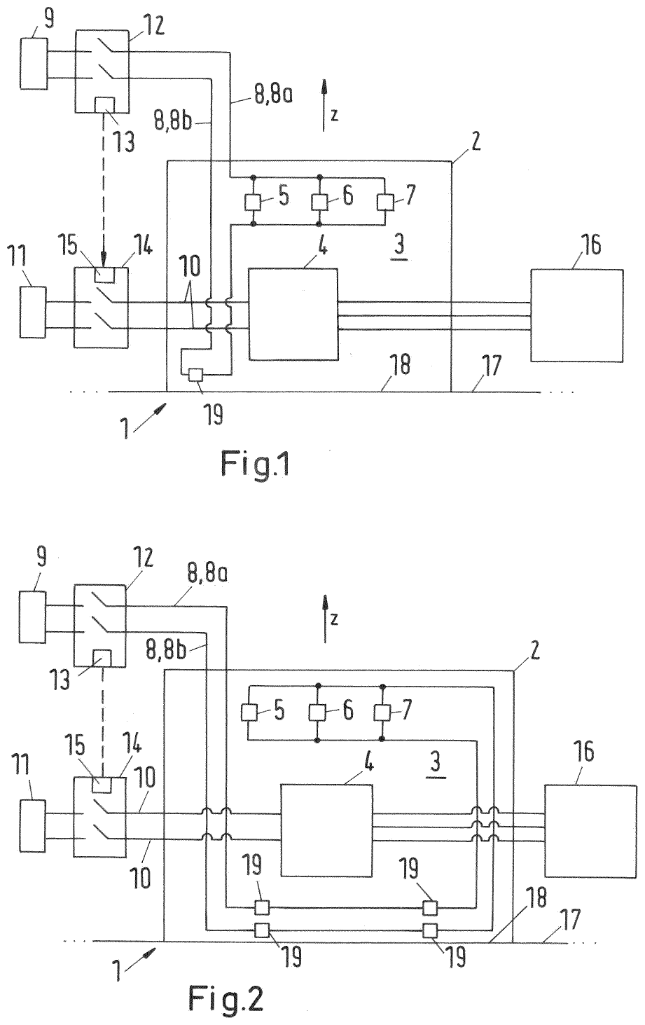

FIG. 2: A schematic block diagram of an inductive power transfer unit according to another embodiment of the invention,

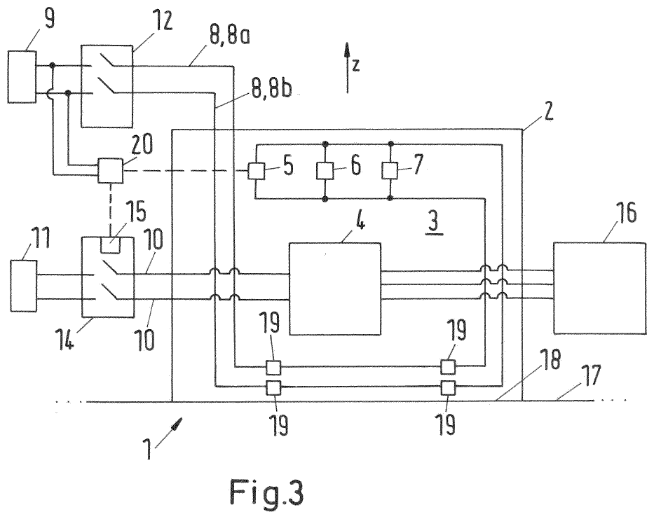

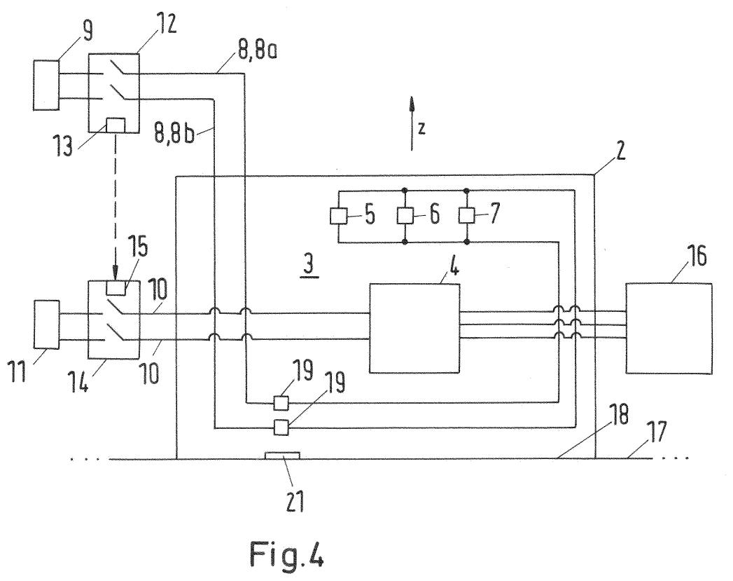

FIG. 3: A schematic block diagram of an inductive power transfer unit according to another embodiment of the invention,

FIG. 4: A schematic block diagram of an inductive power transfer unit according to another embodiment of the invention, and

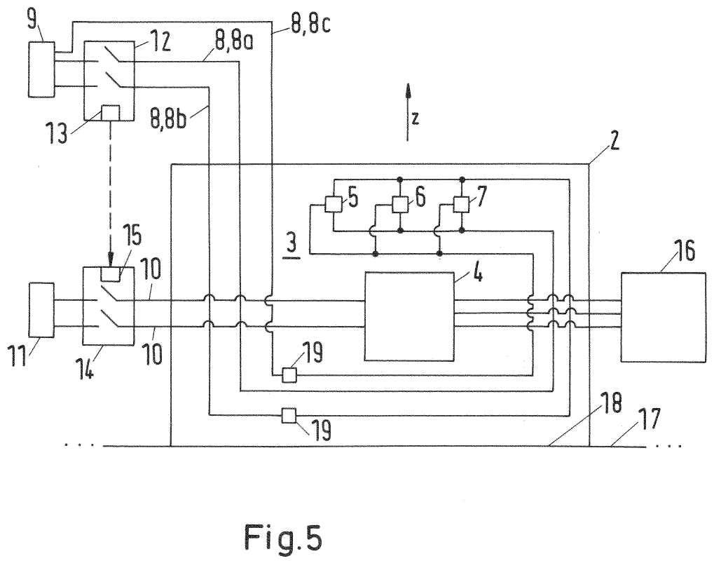

FIG. 5: A schematic block diagram of an inductive power transfer unit according to another embodiment of the invention.

In the following, the same reference numerals denote elements with the same or similar technical features.

In the following, the invention is exemplarily described for an inductive power transfer unit 1. It is, however, clear to the skilled person that the invention can be applied to any system in which a fluid collecting in an inner volume of a housing comprising electronic components, e.g. to a telecommunication device, an electrically operated pump or a distribution station.

FIG. 1 shows a schematic block diagram of an inductive power transfer unit 1 according to the invention. The inductive power transfer unit 1 comprises a housing 2. The housing 2 or at least a part thereof is made of electrically conductive material. Further, the housing 2 can be electrically connected to a ground potential. Further, the unit 1 comprises an inverter 4 which provides or comprises power electronic components and multiple auxiliary electronic components, e. g. a control unit 5, a fan 6 and a relay 7. The control unit 5 can e. g. control an operation of the inverter 4. The inverter 4 provides a power electronic component of the unit 1. The inverter 4 and the auxiliary electronic components 5, 6, 7 are arranged in an inner volume 5 of a housing 2.

In the shown embodiment, in the inductive power transfer unit 1 is a primary unit of a system for inductive power transfer. It is, of course, possible that the inductive power transfer unit 1 provides a secondary unit of said system for inductive power transfer. In this case, the power electronic components arranged in the housing 2 can be different from the shown power electronic components.

Further, the unit 1 comprises an auxiliary power supply line 8. The auxiliary power supply line can e.g. comprise a neutral line, i.e. a return line 8a, and a phase line, i.e. a feeding line 8b. Via the auxiliary power supply line 8, the auxiliary electronic components 5, 6, 7 are electrically connected to an auxiliary voltage supply 9. The auxiliary voltage supply 9 can e. g. supply an auxiliary voltage of 230 V as an alternating current voltage.

Further shown is a main power supply line 10, wherein power input terminals of the inverter 4 are connected to a main power supply unit 11 via the main power supply line 10. Power can be provided to the inverter 4 by AC or DC voltage. In case of an AC power supply, the inverter 4 can provide a converter.

Both, the auxiliary power supply line 8 and the main power supply line 10 comprise an internal section which is arranged within the inner volume 3 of the housing 2 and an external section, which is arranged outside the housing 2. The housing 2 can comprise inlets for the power supply lines 8, 10.

Further, the unit 1 comprises a RCD 12. The auxiliary power supply line 8 is fitted with the RCD 12. This means that the auxiliary electronic components 5, 6, 7 are connected to the auxiliary power supply unit 12 via the RCD 12. In FIG. 1, the RCD 12 is shown in an open state. In this open state, the auxiliary power supply line 8 is interrupted. Thus, no auxiliary voltage and power is supplied to the auxiliary electronic components 5, 6, 7. In an error-free operation, the RCD 12 can adopt a closed state in which the auxiliary electronic 5, 6, 7 are connected to auxiliary power supply unit 9 and power is supplied to said auxiliary electronic components 5, 6, 7 via the RCD.

Schematically indicated is one exposed section 19 of the auxiliary power supply line 8, in particular of the feeding line 8b. The exposed section 19 can e.g. be provided by an uninsulated section of the feeding line 8b and/or by a series terminal.

Further shown is that the exposed section 19 is arranged in a bottom area or bottom volume of the housing 2, in particular below the inverter 4 and the auxiliary electronic components 5, 6, 7 with respect to the vertical direction z. The bottom area or bottom volume provides a fluid collection volume of the housing 2. Fluid, e.g. water, which collects in the inner volume 3, e.g. ingressing water or condensing water, will first collect in said fluid collection volume.

In other words, the exposed section 19 is arranged in between the inverter 4 and the bottom side of the housing 2 or a carrier element 17 in an installed state of the housing 2. It is, for instance, possible, that a series terminal is mounted to a bottom plate of the housing 2, wherein the series terminal is also arranged in the inner volume 3 in which the inverter 4 and the auxiliary electronic components 5, 6, 7 are arranged.

The RCD 12 can change from the closed state to the open state if a residual or failure current occurs. In particular, the RCD 12 can adopt the closed state as long as the currents in a return line 8a and a feeding line 8b are equal. If a residual current occurs, the difference between said currents is greater than zero or greater than a predetermined threshold value, e.g. greater than 30 mA. In this case, the RCD 12 can adopt the open state.

Such a residual current can e. g. occur if fluid penetrates or enters into the inner volume 3 of the housing 2 and/or collects in the inner volume 3 and contacts the auxiliary electronic components 5, 6, 7 or sections of the auxiliary power supply line 8, in particular the exposed sections 19. In this case, the residual current can flow between the exposed section 19 and the housing 2.

The RCD 12 comprises a trip signal interface 13. Via the trip signal interface 13 which can e.g. be provided by an auxiliary contact element of the RCD 12, the RCD 12 is connected to a circuit breaker switch 14 which is fitted to the main power supply line 10. The circuit breaker switch 14 has also a trip signal interface 15 by which the circuit breaker 14 is connected to the RCD 12 by a signal connection. If the RCD 12 detects a residual current, a trip signal can be generated and transmitted from the RCD 12 to the circuit breaker 14. Upon reception of the trip signal, the circuit breaker switch 14 can adopt an open state in which the main power supply line 10 is interrupted and no power is supplied to inverter 4. In an error-free state, the circuit breaker switch 14 can adopt a closed state in which power is supplied to the inverter 4 by the main power supply unit 11.

Further shown is a primary winding structure 16 which is connected to AC output terminals of the inverter 4. The primary winding structure 16 is arranged outside the housing 2. It is, however, also possible to arrange the primary winding structure 16 within the housing 2.

Further shown is that the housing 2 can be arranged on a carrier element 17, e.g. a rack or a ground surface. Not shown are absorber elements, e.g. made of rubber, which absorb or damp mechanical movements, e.g. vibrations, of the housing 2. Further, the housing can be electrically connected to the ground potential via the carrier element 17.

Further indicated is a vertical direction z wherein the vertical direction can be oriented parallel to a direction of a gravitational force.

FIG. 2 shows a schematic block diagram of an inductive power transfer unit 1 according to another embodiment of the invention. In contrast to the embodiment shown in FIG. 1, FIG. 2 shows a more detailed arrangement of the auxiliary power supply line 8, in particular of an internal section of the auxiliary power supply line 8. Schematically indicated are two exposed sections 19 of the return line 8a and two exposed sections of the feeding line 8b of the auxiliary power supply line 8. Again, these exposed sections 19 can be provided by uninsulated sections and/or by series terminals. It is e.g. possible that one series terminal provides one of the exposed sections 19 of the return line 8a and one of the exposed sections of the feeding line 8b. The exposed sections 19 of the return line 8a are not necessarily required for a residual current to flow.

As in the embodiment shown in FIG. 1, these exposed sections 19, in particular of the feeding line 8b, are arranged in a bottom area or bottom volume of the housing 2, in particular below the inverter 4 and the auxiliary electronic components 5, 6, 7 with respect to the vertical direction z. In other words, the exposed sections 19 are arranged in between the inverter 4 and the bottom side of the housing 2 or the carrier element 17 in an installed state of the housing 2. It is, for instance, possible, that series terminals are mounted to a bottom plate of the housing 2, wherein the series terminals are also arranged in the inner volume 3 in which the inverter 4 and the auxiliary electronic components 5, 6, 7 are arranged.

If fluid collects in the inner volume 3 of the housing 2, this fluid will collect in the bottom area which provides a fluid collection volume of the housing 2. Before contacting or enclosing parts of the inverter 4, this fluid will contact the exposed sections 19 and thus generate a residual current between at least one exposed section 19 of the feeding line 8b and the housing 2 which can be detected by the RCD 12.

FIG. 3 shows a schematic block diagram of an inductive power transfer unit 1 according to another embodiment of the invention. In contrast to the embodiment shown in FIG. 2, the RCD 12 has no trip signal interface 13. The unit 1 comprises an evaluation unit 20, where power is supplied to the evaluation unit 20 independently of the power supply to the auxiliary electronic components 5, 6, 7. The evaluation unit 20 can monitor a power supply state of the auxiliary electronic components, e. g. of the control unit 5. This can e. g. performed by a signal connection between the evaluation unit 20 and the control unit 5. If the evaluation unit 20 detects that no power supply is provided to the auxiliary electronic components, a trip signal for the circuit breaker 14 of the main power supply line 10 can be generated.

FIG. 4 shows a schematic block diagram of an inductive power transfer unit 1 according to another embodiment of the invention. In contrast to the embodiment shown in FIG. 2, the feeding line 8b of the auxiliary power supply line 8 is fitted with one exposed section 19. The housing 2 can be made of an insulating, i.e. non-conductive, material but can provide at least one electrically conductive portion 21. The electrically conductive portion 21 can e.g. be electrically connected to a ground potential, e.g. via the carrier element 19. A residual current can flow between the exposed section 19 and the conductive portion 21 of the housing 2 if fluid collects in the inner volume 3 of the housing 2 and contacts at least one of the exposed sections 19 and the conductive portion 21. It is shown that the exposed section 21 is also arranged in a bottom area or bottom volume of the housing 2, in particular on a bottom plate of the housing 2.

FIG. 5 shows a schematic block diagram of an inductive power transfer unit 1 according to another embodiment of the invention. In contrast to the embodiment shown in FIG. 4, the housing 2 does not comprise or provide an electrically conductive portion 21 but is made of an insulating material. In addition to the neutral line 8a and the feeding line 8b, the unit 1, in particular the auxiliary power supply line, can comprise an additional protective line 8c (PE line) which is connected to corresponding terminals of the auxiliary electronic components 5, 6, 7 and the auxiliary power supply unit 9. The protective line 8c is connected to a ground potential.

Similar to the feeding and the neutral line 8a, 8b, the protective line 8c comprises an internal section which is arranged within the inner volume 3 of the housing 2 and an external section, which is arranged outside the housing 2. The housing 2 can comprise an inlet for the protective line 8c. Further, only the neutral line 8a and the feeding line 8b of the auxiliary power supply line 8 are fitted with the RCD 12. In other words, the protective line 8c is not wired through the RCD 12.

Schematically indicated is one exposed section 19 of the feeding line 8b and one exposed section of the protective line 8c. The exposed sections 19 can e.g. be provided by uninsulated sections and/or by a series terminal.

Further shown is that the exposed sections 19 are arranged in a bottom area or bottom volume of the housing 2, in particular below the inverter 4 and the auxiliary electronic components 5, 6, 7 with respect to the vertical direction z. The bottom area or bottom volume provides a fluid collection volume of the housing 2.

In the embodiment shown in FIG. 5, a residual current can flow between the exposed sections 19 of the feeding line 8b and the protective line 8c. Such a residual current will cause a change of the RCD 12 from a closed state to an open state.

1. An electronic unit comprising:
at least one electronic component;
at least one housing for the at least one electronic component;
at least one auxiliary power supply line; and
a residual-current device (RC) switch element,
wherein the at least one auxiliary power supply line is fitted with the RCD switch element and at least one exposed section in such a manner that the RCD switch element triggers when the at least one exposed section of the auxiliary power supply line is exposed to a conductive fluid,
wherein the at least one exposed section is arranged in a fluid collection volume of the housing, and
wherein the unit comprises at least one power electronic component and at least one auxiliary electronic component.

2. The unit according to claim 1, wherein the auxiliary power supply line has an internal section arranged inside the housing and an external section arranged outside the housing, and wherein the external section of the auxiliary power supply line is fitted with the RCD switch element.

3. The unit according to claim 1, wherein the unit further comprises at least one main power supply line, wherein the at least one main power supply line is fitted with a supply line breaking means, wherein the RCD switch element has a trip signal interface, and wherein the trip signal interface is connected to the supply line breaking means.

4. The unit according to claim 1, wherein the unit further comprises at least one evaluation unit, and wherein an interrupted state of the at least one auxiliary power supply line is detectable by the at least one evaluation unit.

5. The unit according to claim 1, wherein the at least one exposed section comprises or is provided by at least one uninsulated section.

6. The unit according to claim 1, wherein the exposed section comprises or is provided by at least one series terminal.

7. The unit according to claim 1, wherein the fluid collection volume is arranged in a bottom section of the housing.

8. The unit according to claim 1, wherein the housing is shaped such that the fluid collection volume is the part of an inner volume of the housing in which a fluid accumulates at first.

9. The unit according to claim 1, wherein the unit further comprises at least one fluid collecting element, wherein the fluid collecting element is designed and/or arranged such that a fluid collected by the fluid collecting element contacts the at least one exposed section or wherein the fluid collecting element is designed and/or arranged such that a residual current occurs if the fluid collecting element has collected a predetermined amount of fluid.

10. (canceled)

11. The unit according to claim 1, wherein the unit is an inductive power transfer unit.

12. A method of manufacturing an electronic unit, the method comprising:
providing a housing of the electronic unit, having a fluid collection volume;
arranging at least one power electronic component and at least one auxiliary electronic component within the housing;
providing at least one auxiliary power supply line having at least one exposed section;
arranging the exposed section in the fluid collection volume;
providing at least one residual-current device (RCD) switch element; and
fitting the at least one RCD switch element to the at least one auxiliary power supply line.

13. The method according to claim 12, wherein at least one main power supply line and at least one supply line breaking means is provided, wherein the at least one main power supply line fitted with the supply line breaking means, and wherein a trip signal interface of the RCD switch element is connected to the supply line breaking means.

14. The method according to claim 12, wherein the exposed section comprises at least one uninsulated section or at least one series terminal.
